(19) United States
(12) Patent Application Publication
(10) Pub. No.: US 2021/0312283 A1
(43) Pub. Date: Oct. 7, 2021

(54) COMPLEX ADAPTIVE SYSTEM

(71) Applicant: COGNITIVE SYSTEMS PTY LTD, Observatory (ZA)

(72) Inventor: Anna Elizabeth Gezina POTGIETER, Observatory (ZA)

(21) Appl. No.: 17/256,686

(22) PCT Filed: Feb. 5, 2019
(86) PCT No.: PCT/IB2019/050897

§ 371 Date: Dec. 29, 2020

(30) Foreign Application Priority Data
Feb. 6, 2018 (ZA) 2018/00761

(51) Int. Cl. G06N 3/08; G16Y 10/75; G06N 3/00; G06N 3/04

(52) U.S. Cl. CPC G06N 3/08; G16Y 10/75; H04W 84/18; G06N 3/0454; G06N 3/006

(57) ABSTRACT

The invention discloses a complex adaptive system, which includes an intelligent software system adapted to perform in-stream adaptive cognition in high volume, high velocity, complex data streams and/or is adapted to act in the environment using distributed software agents called control agents. The system is adapted to sense its environments through sensors and act intelligently upon the environment using actuators. The system is autonomous in that it is adapted to decide how to relate sensor data to actuators in order to fulfil a set of goals through dynamic interaction with their complex and dynamically changing environment. The system consists of distributed agents, located in a networked environment that communicate and coordinate their actions by passing messages.

### FIELD OF INVENTION

The present invention relates to a complex adaptive system.

More particularly, the present invention relates to a complex adaptive system and associated methods that incorporate agent technology, machine learning and automatic adaptation into complex adaptive systems that are situated in highly connected streaming network systems such as wireless sensor networks and the Internet. These systems sense their environments through sensors and act intelligently upon the environment using actuators. These systems are autonomous in that they decide how to relate sensor data to actuators in order to fulfil a set of goals through dynamic interaction with their complex and dynamically changing environments. These systems consist of distributed software components, called agents, located in networked environments that communicate and coordinate their actions by passing messages. The agents are collectively context-aware and interact with each other in order to achieve common goals. These systems are adaptive by using internal models consisting of different levels of evolving hyper structures in order to become better at achieving their goals with experience i.e. being able to change and improve behaviour over time.

### BACKGROUND TO INVENTION

Significant advances in communication technologies are enabling people, processes, physical devices, vehicles, home appliances, and other items embedded with electronics, software, sensors, actuators to connect and exchange data streams and messages through wireless sensor networks and the Internet. In these highly connected environments there is a need for a new generation of intelligent tools that are context-aware, can make sense of their dynamically changing environments and the observed behaviours of animate and inanimate objects and processes in these environments. These tools must be context-aware and able to continuously extract new perishable insights from a variety of data sources.

These tools must be context-aware. Context is any information that characterize the environment of an entity (a person, group of person, a place or an object) relevant to the interaction of the application and the users. It means, understanding the whole environment and current situation of the entity.

Typically these tools must operate in high velocity and high volume sensor—and event streams and immediately harness these insights to modify processes in these highly connected environments in order to augment behaviours of animate and inanimate objects. There is a further need for systems that learn from experience and become better in achieving their goals with experience in order to change and improve behaviour over time—“adaptive systems”.

Most machine learning systems, in highly connected environments, employ centralised computing models that require an extremely large amount of data and computing power to be effective, which is costly and time intensive.

According to Gartner (May 2017—https://www.gartner.com/doc/3718717/fog-computing-iot-new-paradigm) “There is a growing consensus within the industry that applications in the so-called Industrial Internet require a greater degree of system intelligence enabled at the edge, particularly due to security and analytics concerns. Fog computing has been proposed as a new model to achieving this.” The concept of Fog computing was first introduced by Cisco in 2012 to address the challenges of IoT applications in conventional Cloud computing. IoT devices/sensors are highly distributed at the edge of the network along with real-time and latency-sensitive service requirements. Since Cloud data centres are geographically centralized, they often fail to deal with storage and processing demands of billions of geo-distributed IoT devices/sensors. As a result, congested network, high latency in service delivery, poor Quality of Service (QoS) are experienced.

Centralised cloud-based IoT Frameworks generally are not adaptive in dynamically changing environments.

These systems lack adaptive feedback—they train and retrain machine-learning models after-the-fact in centralised cloud-based facilities and then push these pre-trained models to the edge. These models, cannot adapt at the edge as they are data and processing hungry and require millions of labelled samples for training.

Most of these systems can therefore not automatically improve actuators due to the high volume, velocity and variety of data streams in these environments. The shortcoming of these systems is that their pre-trained machine learning models are mostly static and cannot adapt and evolve to new environmental situations. These models have to be re-trained to incorporate new changes and cannot evolve as the changes occur in the environment. Highly interconnected environments are constantly evolving and are characterised by environmental conditions that cannot be predicted by static models. Machine learning systems employing pre-trained models that cannot adapt in real-time to high variety, volume and velocity streams, are not suitable to environments where operations are time-critical or communication infrastructure is unreliable. In these high velocity and high volume systems, delays due to latency caused by the round-trip to centralised automated reasoning facilities or inappropriate actions informed by non-adaptive machine-learning models, can have fatal consequences. Examples include vehicle telematics, where the prevention of life-threatening activities such as hijackings, collisions and accidents cannot afford the latency caused by round-trip to the centralised reasoning facilities or wrong decisions by reasoning using non-adaptive machine learning models.

An agent is defined as a simple independent software component that communicates with and act on behalf of a thing (for example a sensor/video camera/object) or act upon emerging relationships between things in the networks of connected devices or things. In distributed systems the agents communicate and coordinate their actions by passing messages amongst themselves to achieve common goals. These agents are collectively adaptive in that they learn from experience and each other. In order to become better at achieving their goals with experience, they change and improve their collective behaviour over time.

A complex adaptive system is characterized by emergence, which results from the interactions among individual system components (agents), and between system components (agents) and the environment. A complex adaptive system is able to adapt due to its ability to learn from its interactions with the dynamically changing and uncertain environment. It learns from, and understands patterns, extracted from these interactions and adapts its actions in order to better achieve its goals in the environment.

All complex adaptive systems maintain internal models, consisting of hyper structures representing “regularities” in the information about the system's environment and its own interaction with that environment. Hyper structures are higher-order structures that emerge from the collective behaviour of the agents. Complex adaptive systems use these hyper structures to act in the real world (Gell-Mann, M. (1994). The Quark and the Jaguar (2nd Ed.). London: Little, Brown and Company. Holland, J. H. (1995). Hidden Order: How Adaptation Builds Complexity. Massachusetts: Addison-Wesley Publishing Company Inc.)

It is an object of the invention to suggest complex adaptive systems, deployed in highly connected environments, which will assist in overcoming these problems.

### SUMMARY OF INVENTION

According to the invention, a complex adaptive system, which includes an intelligent software system adapted to perform in-stream adaptive cognition in high volume, high velocity, complex data streams.

The system may be adapted to sense its environments through sensors and act intelligently upon the environment using actuators.

The system may be autonomous in that it decides how to relate sensor data to actuators in order to fulfil a set of goals through dynamic interaction with their complex and dynamically changing environment.

The system may consist of distributed agents, located in a networked environment that communicate and coordinate their actions by passing messages. The agents are collectively context-aware and interact with each other in order to achieve common goals. These systems are adaptive by using internal models consisting of different levels of evolving hyper structures in order to become better at achieving their goals with experience i.e. being able to change and improve behaviour over time.

The system may be adapted to use a distributed AND/OR Process Model that feeds of short term memories that learns incrementally from contextual data sources in order to become better at achieving their goals with experience i.e. being able to change and improve behaviour over time.

The embedded distributed software agents may collectively evolve long-term memories from mined patterns in short term memories as well as other external data sources in networked environments.

The system may include a flexible infrastructure where software agents, storage, network and security resources are assigned on the fly where and when needed.

The system may be implemented in a wireless sensor network.

The system may be implemented in the Internet of Things (IoT), including people, processes, data, and video.

The system may be adapted to be used to implement a cybersecurity system for the Internet of Things (IoT), including people, processes, data, and video.

Also according to the invention, a method for operating a complex adaptive system as herein described.

Also according to the invention a computer-readable media storage instructions for carrying out the steps of a method of operating the complex adaptive system as herein described.

Also according to the invention, a complex adaptive system includes an intelligent software system that maintains internal models consisting of adaptable hyper structures in order to learn from and adapt to their dynamically changing environments.

These hyper structures may be distributed through the networked environment.

Also according to the invention, a complex adaptive system includes an intelligent software system consisting of distributed agents observing and receiving data from various sources in the environment (things) including people, living organisms, processes, data, and other things (for example sensors, endpoint devices, video sources); the distributed agents learn from the data by updating hyper structures in their internal models.

Also according to the invention, a complex adaptive system adapted to act in the environment using distributed software agents called control agents.

These control agents may be informed by control hyper structures that are in turn, informed by the hyper structures in the internal models.

These agents may communicate and coordinate their actions by passing messages.

The agents may interact with each other in order to achieve common goals.

These systems may be adaptive by using different levels of evolving hyper structures in order to become better at achieving their goals with experience i.e. being able to change and improve their behaviour overs time.

Also according to the invention, a method for operating a complex adaptive system and computer-readable media storage instructions for carrying out the steps of the method of operating the complex adaptive system herein-described.

The hyper structures may be distributed Bayesian Networks.

The distributed Bayesian Networks may be organised into short term memories that are situated closest to the data sources at the edge of a communication network.

These Bayesian networks may tap into contextual input streams such as streams from sensors, endpoint devices and video cameras and learn occurrence frequencies of contextual patterns over time.

Short term memories may be controlled by distributed software agents called Short-Term Memory Agents.

The Short Term Memory Agents may be situated closest to the data sources in a connected environment such as a wireless sensor network or the Internet of Things.

The distributed Bayesian Networks may be organised into long term memories that connect to inferences made by short term memories, as well as other external and networked data sources.

The long term memories may capture long term temporal patterns and may be able to evolve in order to capture new emergent patterns, combining patterns learnt in the short term memories with the variety of external data sources.

Any new patterns may be synchronised back to the short term memories as soon as they occur.

Long term memories may form a hierarchy depending on the level of intelligence required.

Long term memories may be controlled by distributed software agents called Long-Term Memory Agents.

The system may be used to implement a Learning Subsystem that orchestrates and manages the long-term and short term memories and agencies, and provides a user-friendly interface to visualise patterns mined by the long term memories in order to gain insights into the evolving patterns mined by the Long Term Memory Agents as they happen.

The Learning Subsystem can be used to upload external data or feedback from users in order to assist automated learning by the Long-Term Memory Agents.

The hyper structures may be distributed AND/OR process models that are software processes that implement goals, and the rules that dictate how the goals must be achieved.

AND/OR process trees may be controlled by distributed software agents called Control Agents.

The Control Agents may be situated at the network edge closest to the data sources in a connected environment such as a wireless sensor network or the Internet of Things.

The system may be used to implement a Control Subsystem that provides a user-friendly interface to define logical rules and goals in a declarative language in order to allow goals and rules to automatically exploit insights in short term memories to act automatically closest to the data sources.

The Control Subsystem may implement a Difference Engine that will compare desired goals against actual goals in order to determine if the goals were achieved successfully.

The Control Subsystem may be used to define logical rules and goals to exploit insights to raise early alerts and alarms in alarm control dashboards.

The declarative language may be a parallel logic programming language. The parallel logic programming language may be Guarded Horn Clauses.

### BRIEF DESCRIPTION OF DRAWINGS

The invention will now be described by way of example with reference to the accompanying schematic drawings.

In the drawing, there is shown in:

FIG. 1: a high level overview of implementation of different levels of hyper structures in a complex adaptive system in accordance with the invention;

FIG. 2: a detailed diagram illustrating the organisation of hyper structures into distributed memories, A-Brains and B-Brains and the streams that flow through these,—memories and streams all orchestrated and managed by a centralised HUB;

FIG. 3: a diagram illustrating the flow of data from the sensors through hyper structures to the actuators, managed by the Learning Subsystem, Control Subsystem, Stream Control Subsystem and Competence Subsystem;

FIG. 4: a diagram illustrating the context-aware Publish-Subscribe to patterns in the streams. The Short Term Memory Agents subscribe to variables in the context streams, and publish Bayesian effects to the streams, inferred by the Fixed Structure Bayesian Networks (FBNs). Control Agents subscribe to context variables and Bayesian effects, and activates the AND/OR Process models that infer logic conclusions. These logic conclusions are used by the Competence Agents to execute the most appropriate workflows that takes actions in the environment. The Competence Agents compared observed goals with desired goals and activates the difference engine to modify the goals. Observed Effects are sent back to the Long Term Memory Agents in order to update the Evolving Bayesian Networks (EBNs). The Long Term Agents learn new cause effect patterns from the context streams, the external streams and the observed effects, and synchronise any new patterns back to the Fixed Bayesian Networks;

FIG. 5: an AND/OR Process Model specified in Communicating Sequential Processes, or CSP, is a language for describing patterns of interaction (Hoare, C. A. R. 1985. Communicating Sequential Processes. London: Prentice-Hall.)—Google's Go language was strongly influenced by CSP; and

FIG. 6: a diagram illustrating the connection diagram for process OR and its sub-processes.

### DETAILED DESCRIPTION OF DRAWINGS

According to the invention, the complex adaptive system includes an intelligent software system that maintains internal models consisting of adaptable hyper structures in order to learn from and adapt to their dynamically changing environments. These hyper structures are distributed through the networked environment.

Also according to the invention, a complex adaptive system includes an intelligent software system consisting of distributed agents observing and receiving data from various sources in the environment (things) including people, living organisms, processes, data, and other things (for example sensors, endpoint devices, video sources); the distributed agents learn from the data by updating hyper structures in their internal models.

Also, according to the invention, the complex adaptive system will act in the environment using distributed software agents called control agents. These control agents, are informed by control hyper structures that are in turn, informed by the hyper structures in the internal models. These agents communicate and coordinate their actions by passing messages. The agents interact with each other in order to achieve common goals. These systems are adaptive by using different levels of evolving hyper structures in order to become better at achieving their goals with experience i.e. being able to change and improve their behaviour overs time.

Yet further according to the invention, a method for operating a complex adaptive system and computer-readable media storage instructions for carrying out the steps of the method of operating the complex adaptive system herein-described.

The hyper structures may be distributed Bayesian Networks (disclosed in patent (WO2003007101 COMPLEX ADAPTIVE SYSTEMS)

The distributed Bayesian Networks may be organised into short term memories that are situated closest to the data sources at the edge of a communication network. These Bayesian networks tap into contextual input streams such as streams from sensors, endpoint devices and video cameras and learn occurrence frequencies of contextual patterns over time.

Short term memories may be controlled by distributed software agents called Short-Term Memory Agents.

The Short Term Memory Agents may be situated closest to the data sources in a connected environment such as a wireless sensor network or the Internet of Things.

The distributed Bayesian Networks may be organised into long term memories, managed by Long Term Memory Agents. These agents tap into occurrence frequencies of contextual patterns in the short term memories, as well as into external streams and adaptive feedback from observed goals in the environment. Contextual patterns may include features extracted from context streams for example generic features by deep convolutional neural networks.

The long term memories may mine long term temporal patterns and may be able to evolve in order to capture new emergent patterns, combining patterns learnt in the short term memories with the variety of external data sources. Any new patterns may be synchronised back to the short term memories as soon as they occur. Long term memories may form a hierarchy depending on the level of intelligence required.

The system may be used to implement a Learning Subsystem that orchestrates and manages the long-term and short term memories and agencies, and provides a user-friendly interface to visualise patterns mined by the long term memories in order to gain insights into the evolving patterns mined by the Long Term Memory Agents as they happen.

The Learning Subsystem can be used to upload external data or feedback from users in order to assist automated learning by the Long-Term Memory Agents.

The hyper structures may be distributed AND/OR process models that are software processes that implement goals, and the rules that dictate how the goals must be achieved.

AND/OR process trees may be controlled by distributed software agents called Control Agents.

The Control Agents may be situated at the network edge closest to the data sources in a connected environment such as a wireless sensor network or the Internet of Things.

The system may be used to implement a Control Subsystem that provides a user-friendly interface to define logical rules and goals in a declarative language in order to allow goals and rules to automatically exploit insights in short term memories to act automatically closest to the data sources. The Control Subsystem may implement a Difference Engine that will compare desired goals against actual goals in order to determine if the goals were achieved successfully (Minsky, M. (1988). The Society of Mind (First Touchstone Ed.). New York: Simon & Schuster.). It will keep records of the performance of the goal e.g. how well the goal mitigated an actual situation obtained from incident report. In the case of false positives or false negatives, both the rules and goals in the AND/OR process model and Bayesian Network classification in the long-term memory is continuously adjusted in order to improve the Bayesian Network classification and the goal execution.

The Control Subsystem may be used to define logical rules and goals to exploit insights to raise early alerts and alarms in alarm control dashboards.

The declarative language may be a parallel logic programming language. The parallel logic programming language may be Guarded Horn Clauses.

Guarded Horn Clauses (GHC) are a set of Horn clauses augmented with a ‘guard’ mechanism.

A GHC program is a finite set of guarded Horn clauses of the following form:

H:-G1, . . . , Gm|B1, . . . , Bn. (m≥0,n≥0).
where H, Gi's, and Bi's are atomic formulas. H is called a clause head, Gi's are called guard goals, and Bi's are called body goals. The operator ‘|’ is called a commitment operator. The part of a clause before ‘|’ is called the guard, and the part after ‘|’ is called the body. Note that the clause head is included in the guard. The set of all clauses whose heads have the same predicate symbol with the same arity is called a procedure. Declaratively, the above guarded Horn clause is read as “H is implied by G1, . . . , and Gm and B1, . . . , and Bn”.

A goal clause has the following form: :-B1, . . . , Bn. (n≥0).

This can be regarded as a guarded Horn clause with an empty guard. A goal clause is called an empty clause when n is equal to 0.

The Control Subsystem may automatically generate pipelined AND/OR processes that are deployed to execute goals that control actuators in the environment.

AND/OR processes are software processes that may unify the guards of the Guarded Horn Clauses with inputs received from sensors in the environment or from effects inferred by Bayesian Networks managed by Short-Term Memory Agents.

In the AND/OR processes, the bodies of all clauses with successful guards are executed in parallel, atomic formulas can activate agents to execute processes closest to the data sources.

An example of such a system is in food processing, to enable natural, healthier ways to produce food with no compromise on the eating experience. The Long-Term Memory Agents then mine the temporal relationships between complex non-linear interrelationships between functional properties of proteins, thermal processing parameters and protein physicochemical properties. These long-term patterns are stored as long-term memories and are synchronised with the short-term memories. The Control Agents then actuate the optimum process control goals and rules to tightly control the functionality. In adaptive feedback, the actual functional property changes in response to automated temperature changes are fed back to both the long-term memory and predicates are adapted in the AND/OR process model to optimise the thermal processing behaviours.

Another example of such a system is in vehicle telematics to continuously monitor driver behaviour in order to mitigate risk. The long-term memories store the geospatial behaviour patterns e.g. points of interest, as well as the behaviour fingerprint of acceleration behaviour, braking behaviour, etc. . . . . These long-term patterns are synchronised with the short-term memory. As soon as anomalous behaviour sequences are detected w.r.t. speeding, harsh-braking and driving at high speeds, and in areas not usually frequented by the driver, the Control Agencies actuates an early-warning of a possible life-threatening situation such as a hijacking, or a possible stolen vehicle, and initiate the appropriate automatic preventative recovery workflows or rescue measures. In the feedback loop, the incident report is shared with the Control Agencies and the Long Term Memory Agents to learn how well the prediction matched the actual incident, in order to improve the goals.

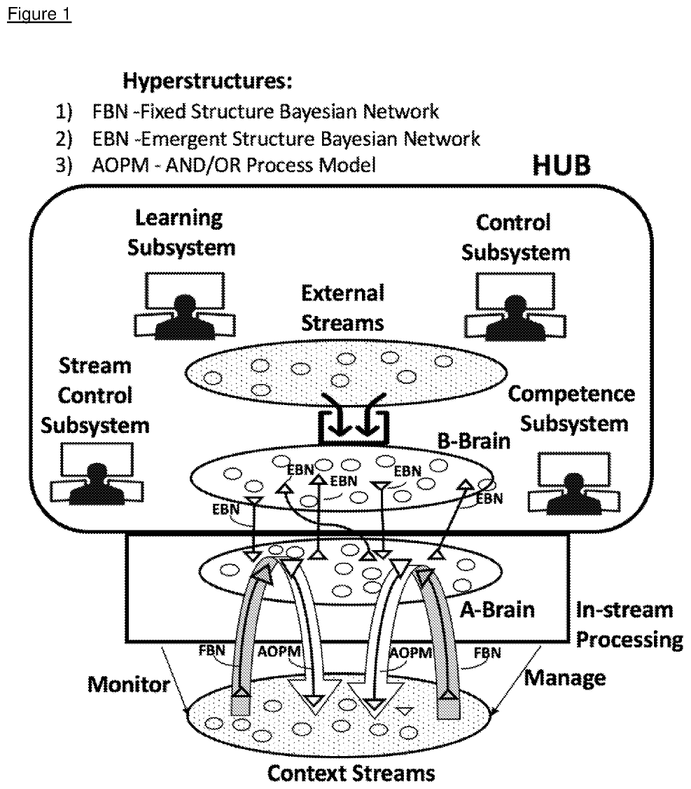

FIG. 1 is a top-level illustration of how different levels of hyper structures are implemented in the present invention. In Minsky's Society of Mind, internal observation mechanisms called A-Brains and B-Brains maintain internal models consisting of hyper structures called K-Lines. Each K-Line is a wire-like structure that attaches itself to whichever mental agents are active when a problem is solved or a good idea is formed (Minsky, 1988). The A-Brain predicts and controls what happens in the environment, and the B-Brain predicts and controls what the A-Brain will do. The B-Brain supervises how the A-Brain learns either by making changes in the A-Brain indirectly or by influencing the A-Brain's own learning processes.

FIG. 1 illustrates the implementation of A-Brains and B-Brains in the current invention. The A-Brain has inputs and outputs that are connected to an environment that produces a variety of complex data streams at a high velocity, with a high volume. The B-Brain is connected to the A-Brain. The A-Brain can sense and adapt to the constantly changing environment, and the B-Brain can influence and supervise the learning in the A-Brain.

The invention uses three different forms of K-Lines as hyper structures to implement A-Brains and B-Brains, indicated in FIG. 1, namely:

### 1) FBN

A Fixed Structure Bayesian Network (FBN) is a distributed Bayesian Network that is attached to streaming contextual data sources. These networks have known structure, mined and maintained by the B-Brain. The FBN's receive context streams, configured and maintained by the Learning Subsystem. Observed phenomena in the streaming inputs triggers effects in the B-Brains through distributed Bayesian inference (disclosed in patent (WO2003007101 COMPLEX ADAPTIVE SYSTEMS). The FBN's at the same time learn from observed phenomena in the input streams.

### 2) EBN

An Emergent Structure Bayesian Network (EBN) is a distributed Bayesian Network. EBN's are attached to the effects inferred by the FBN's, as well as other data sources such as incident reports, human insights and other sources. These sources are configured and maintained by the Learning Subsystem. These Bayesian network structures are continuously evolving from patterns mined and maintained by the B-Brain. Strong patterns are synced back to the FBN's in the A-Brain empowering these networks to infer effects from observed phenomena in order to act timely upon inferred effects.

### 3) AOPM

An AND/OR Process Model (AOPM) represents a logical hyper structure whose internal nodes are labelled either “AND” or “OR”. Given a AND/OR Process Model H and a valuation over the leaves of H, the values of the internal nodes and of H are defined recursively: An OR node is TRUE if at least one of its children is TRUE.

Collections of FBN's form short-term memories and collections of EBN's form long-term memories. Memories are orchestrated by the Learning Subsystem.

The Learning Subsystem is a software environment that allows the mined patterns of memories to be visualised with user-friendly dashboards.

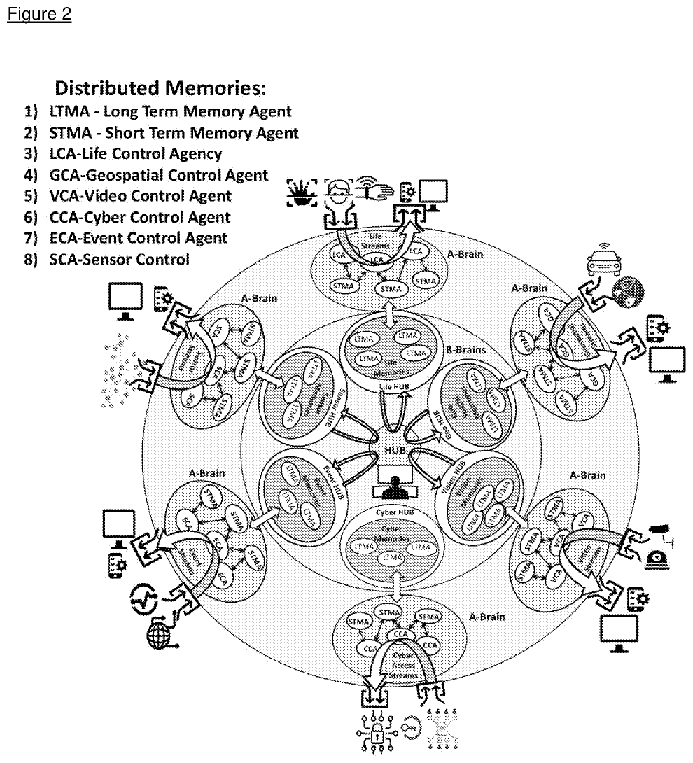

FIG. 2 is a detailed diagram illustrating the organisation of hyper structures into distributed memories, A-Brains and B-Brains and the streams that flow through these, memories and streams all orchestrated and managed by a centralised HUB.

A-Brains manages context-specific memories and context streams, on the network edge, namely:
Geospatial Streams that flow through the geospatial control agencies (GCAs). Short Term Memory Agencies (STMAs) infer the most probable effects from observed causes using distributed Bayesian Inference in the Fixed Structure Bayesian Networks (FBNs) in the short term memories. The most probable effects determines the flow of data through the AND/OR Process Models managed by the Geospatial Control Agencies (GCAs), determining actions that are taken in the environment. Examples include continuous monitoring and early warning in fleet monitoring systems, asset tracking, geofencing, etc.
Video Streams that flow through the video control agencies (VCAs) are converted to event streams using feature extraction algorithms such as adaptive segmentation, convolutional neural networks, scale invariant feature transforms (SIFT) etc. Short Term Memory Agencies (STMAs) infer the most probable classifications and predict the most probable effects from observed causes using distributed Bayesian Inference in the Fixed Structure Bayesian Networks (FBNs) in the short term memories. The most probable effects determine the flow of data through the AND/OR Process Models managed by the video control agencies (VCAs), determining which actions should be taken in the environment. Examples include continuous monitoring and early warning of human behaviour in video surveillance applications to monitor health of users in for example old age homes, gyms, perimeter monitoring, access control etc.
Cyber Access Streams that flow through the cyber control agencies (CCAs). Short Term Memory Agencies (STMAs) infer the most probable effects from observed causes using distributed Bayesian Inference in the Fixed Structure Bayesian Networks (FBNs) in the short term memories. The most probable effects determine the flow of data through the AND/OR Process Models managed by the cyber control agencies (CCAs), determining which actions are taken in the cyber environment. Distributed Ledgers are incorporated into the distributed AND/OR process models to ensure security of critical cyber assets. Examples include continuous monitoring and early warning of anomalous network access patterns in order to ensure distributed virtual enterprise security.
Event Streams that flow through the event control agencies (ECAs). Short Term Memory Agencies (STMAs) infer the most probable effects from observed causes using distributed Bayesian Inference in the Fixed Structure Bayesian Networks (FBNs) in the short term memories. The most probable effects determine the flow of data through the AND/OR process model managed by the event control agencies (ECAs), determining which actions are taken in the environment. Examples include continuous monitoring and early warning of trend changes in automated trading, mining temporal patterns from environmental data, fraud detection in enterprise financial streams, etc.
Sensor Streams that flow through the sensor control agencies (SCAs). Short Term Memory Agencies (STMAs) infer the most probable effects from observed causes using distributed Bayesian Inference in the Fixed Structure Bayesian Networks (FBNs) in the short term memories. The most probable effects determine the flow of data through the AND/OR Process Models, which are managed by the sensor control agencies (SCAs), determining which actions are taken in the environment. Examples include the use of wireless sensor networks to continuously monitor health of livestock herds in order to detect anomalies in herd behaviour and detection of animals in distress due to theft.
Life Streams that flow through the life control agencies (LCAs). Short Term Memory Agencies (STMAs) infer the most probable effects from observed causes using distributed Bayesian Inference in the Fixed Structure Bayesian Networks (FBNs) in the short term memories. The most probable effects determine the flow of data through the AND/OR Process Models, which are managed by the life control agencies (LCAs), determining which actions are taken in the environment. Examples include the use of biometrics—e.g. ‘selfies’ real-time photo compared with image scanned by mobile device, or the use of wearables to monitor health of individuals.

B-Brains are managed by the following specialised HUBS, forming part of the centralised HUB:
Vision HUB—managing the Vision Memories (B-Brains)
Geo HUB—managing the Geo Spatial Memories (B-Brains)
Cyber HUB—managing the Cyber memories (B-Brains)
Event HUB—managing the Event Memories (B-Brains)
Sensor HUB—managing the Cyber Memories (B-Brains)
Life HUB—managing the Life Memories (B-Brains)

Each of the above HUBs provides user interfaces that does the following:
Orchestrates, manages and synchronise the Long Term Memory Agents (LTMAs) and Short Term Memory Agents (STMAs)
Provides a user-friendly interface to visualise patterns mined by the long term memories in order to gain insights into the data streams received by the system.
Provides the interfaces to upload external data or feedback from users in order to assist automated learning by the Long-Term Memory Agents.
Provides the interfaces to define logical rules and goals to exploit insights to raise early alerts and alarms in alarm control dashboards.
Automatically generate pipelined AND/OR processes that are deployed to execute goals that control actuators in the environment.
Orchestrated and manages streams and actuators
Orchestrates and manages containerised memories and agencies through Docker, Kubernetes and Prometheus in the networked environment.

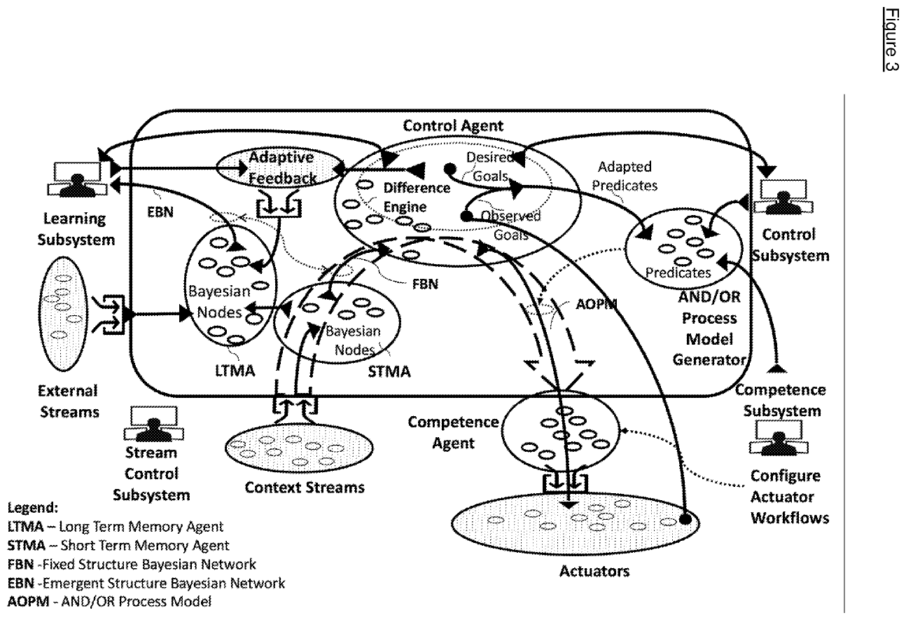

FIG. 3 is a diagram illustrating the flow of context streams through hyper structures to the actuators.

Short Term Memory Agents (STMAs) subscribe to variables of interest in the context streams. The STMA's present the values of these variables as evidence to Bayesian nodes in the Fixed Structure Bayesian Networks FBNs. Effects are inferred through distributed Bayesian inference (disclosed in patent (WO2003007101) COMPLEX ADAPTIVE SYSTEMS), which are added to the context streams. The FBN's at the same time learn from observed phenomena in the input streams, collectively performing Bayesian learning in distributed Bayesian behaviour networks with known structure and no hidden variables. STMAs are configured and maintained by the Learning Subsystem. The Control Agents are situated at the network edge closest to the data sources and manages distributed logic AND/OR process models that are software processes that implement logic goals, and the rules that dictate how desired goals must be achieved. The Control Agents subscribe to variables of interest and effects inferred by the FBNs in the enhanced context streams and instantiates variables in the logic predicates of the AND/OR Process Models, and triggers the logic reasoning. The AND/OR Process Models take premises from the variables and Bayesian effects subscribed to by the Control Agents, perform distributed resolution refutation and generate conclusions to the goals that the AND/OR Process Models are solving.

Competence Agencies subscribe to variables of interest in the enhanced context streams, including contextual variables, Bayesian effects inferred by the FBNs and conclusions drawn by the AND/OR Process Models and activate the best suited workflows that determine which actions are taken in the environment. The Competence Subsystem provides a user-friendly interface to configure the actuator workflows that is managed by the Competence Agencies.

The Control Subsystem provides a user-friendly interface to define logical rules and goals in a declarative language in order to allow goals and rules to automatically exploit insights in short term memories to act automatically closest to the data sources. The Control Subsystem furthermore implements a Difference Engine that will compare desired goals against actual goals in order to determine if the goals were achieved successfully (Minsky, 1988). It keeps records of the performance of the goal e.g. how well the goal mitigated an actual situation obtained from incident report. In the case of false positives or false negatives, both the rules and goals in the AND/OR process models and Bayesian Network classification in the long-term memory are continuously adjusted in order to improve the Bayesian Network classification and the goal execution.

The declarative language consists of Goals and Rules in Guarded Horn Clauses. The AND/OR Process Model Generator generates the AND-OR Model that is embedded into the stream processing. As soon as the Difference Engine optimises a goal through changed predicates, the AND/OR Process Model is updated.

Long Term Memory Agents (LTMAs) receive occurrence frequencies of contextual patterns over time from FBN's, as well as other data sources such as incident reports, adaptive feedback from human insights and other external sources. LTMAs are configured and maintained by the Learning Subsystem. Each Emergent Structure Bayesian Network (EBN) is a distributed Bayesian Network. LTMAs collectively perform Bayesian learning in distributed Bayesian behaviour networks with unknown structure and hidden variables, continuously evolving these Bayesian network structures using incremental Bayesian learning as in (Friedman, N. and Goldszmidt, M. (1997). Sequential update of Bayesian network structure. In Proceedings of the 13th Conference on Uncertainty in Artificial Intelligence (UAI 97), pages 165-174.) (Yasin, A. and Leray, P. (2013). Incremental Bayesian network structure learning in high dimensional domains. 5th International Conference on Modelling, Simulation and Applied Optimization (ICMSAO)). Emergent patterns are synced back to the FBN's in the A-Brain as soon as they occur. The Learning Subsystem can be used to upload external data or feedback from users in order to assist automated learning by the Long-Term Memory Agents.

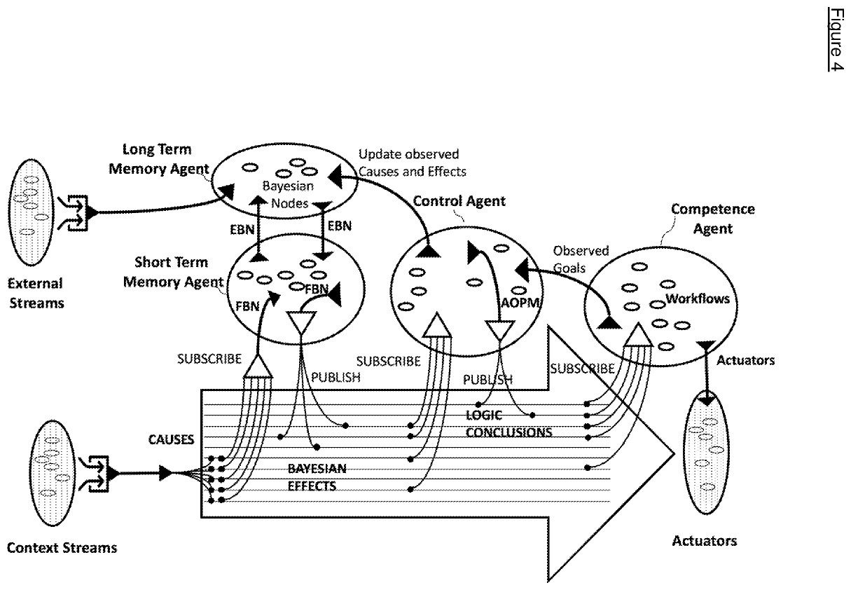

FIG. 4 illustrates the context-aware Publish-Subscribe to patterns in the streams. The Short Term Memory Agents subscribe to variables in the context streams, and publish Bayesian effects to the streams, inferred by the Fixed Structure Bayesian Networks (FBNs). Control Agents subscribe to context variables and Bayesian effects, and activates the AND/OR Process models that infer logic conclusions. These logic conclusions are used by the Competence Agents to execute the most appropriate workflows that takes actions in the environment. The Competence Agents compared observed goals with desired goals and activates the difference engine to modify the goals. Observed Effects are sent back to the Long Term Memory Agents in order to update the Evolving Bayesian Networks (EBNs). The Long Term Agents learn new cause effect patterns from the context streams, the external streams and the observed effects, and synchronise any new patterns back to the Fixed Bayesian Networks.

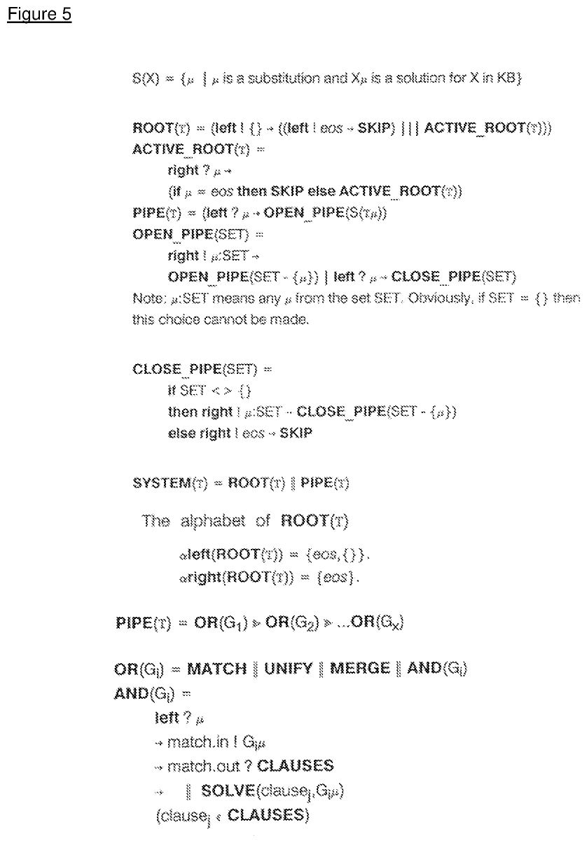

FIG. 5 is the AND/OR Process Model used by the Difference Engine, specified in CSP—a language for describing patterns of interaction (Hoare, 1985)—Google's Go language was strongly influenced by CSP.

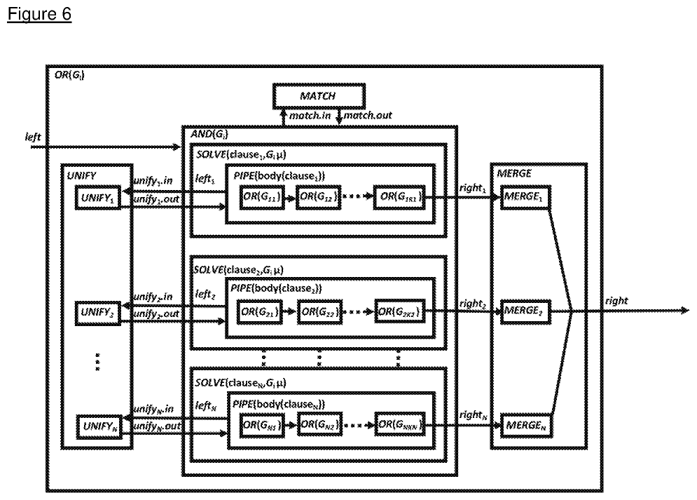

FIG. 6 is a diagram illustrating the connection diagram for process OR and its sub-processes.

1.-45. (canceled)

46. A complex adaptive system, which includes an intelligent software system that maintains internal models consisting of adaptable hyper structures in order to learn from and adapt to their dynamically changing environments, in which these hyper structures are distributed through the network environment, and includes an intelligent software system consisting of distributed agents observing and receiving data from various sources in the environment including people, living organisms, processes, and data; the distributed agents learn from the data by updating hyper structures in their internal models, in which the intelligent software system is adapted to perform in-stream adaptive cognition in high volume, high velocity, complex data streams and/or is adapted to act in the environment using distributed software agents called control agents, and is adapted to sense its environments through sensors and act intelligently upon the environment using actuators, and which includes hyper structures which are distributed Bayesian Networks organized into short term memories that are situated closest to the data sources at the edge of a communication network, and is autonomous in that it is adapted to decide how to relate sensor data to actuators in order to fulfil a set of goals through dynamic interaction with their complex and dynamically changing environment.

47. The system as claimed in claim 46, which is adaptive by using internal models consisting of different levels of evolving hyper structures in order to become better at achieving their goals with experience i.e. being able to change and improve behaviour over time.

48. The system as claimed in claim 46, which is adapted to use a distributed and/or process model that feeds of short term memories that learns incrementally from contextual data sources in order to become better at achieving their goals with experience i.e. being able to change and improve behaviour over time.

49. The system as claimed in claim 46, which includes embedded distributed software agents which are adapted to collectively evolve long-term memories from mined patterns in short term memories as well as other external data sources in networked environments.

50. The system as claimed in claim 46, which is adapted to be implemented in a wireless sensor network and/or in the Internet of Things (IoT), including people, processes, data, and video and/or adapted to be used to implement a cybersecurity system for the Internet of Things (IoT), including people, processes, data, and video.

51. The system as claimed in claim 46, which includes control agents which are informed by control hyper structures that are in turn, informed by the hyper structures in the internal models.

52. The system as claimed in claim 46, which is adaptive by using different levels of evolving hyper structures in order to become better at achieving their goals with experience.

53. The system as claimed in claim 46, in which the Bayesian networks tap into contextual input streams such as streams from sensors, endpoint devices and video cameras and learn occurrence frequencies of contextual patterns over time and/or in which the short term memories are controlled by distributed software agents called Short-Term Memory Agents situated closest to the data sources in a connected environment such as a wireless sensor network or the Internet of Things.

54. The system as claimed in claim 46, in which the distributed Bayesian Networks are organized into long term memories that connect to inferences made by short term memories, as well as other external and networked data sources and in which the long term memories capture long term temporal patterns and are able to evolve in order to capture new emergent patterns, combining patterns learnt in the short term memories with the variety of external data sources.

55. The system as claimed in claim 46, in which any new patterns are synchronised back to the short term memories as soon as they occur and in which the long term memories form a hierarchy depending on the level of intelligence required and in which the long term memories are controlled by distributed software agents called Long-Term Memory Agents.

56. The system as claimed in claim 46, which is adapted to be used to implement a learning subsystem that orchestrates and manages the long-term and short term memories and agencies, and provides a user-friendly interface to visualise patterns mined by the long term memories in order to gain insights into the evolving patterns mined by Long Term Memory Agents as they happen and in which the Learning Subsystem is adapted to be used to upload external data or feedback from users in order to assist automated learning by the Long-Term Memory Agents.

57. The system as claimed in claim 46, in which Control Agents are situated at the network edge closest to the data sources in a connected environment such as a wireless sensor network or the Internet of Things.

58. The system as claimed in claim 46, which is adapted to implement a Control Subsystem that provides a user-friendly interface to define logical rules and goals in a declarative language in order to allow goals and rules to automatically exploit insights in short term memories to act automatically closest to the data sources, in which the Control Subsystem is adapted to implement a Difference Engine that will compare desired goals against actual goals in order to determine if the goals were achieved successfully and in which the Control Subsystem is used to define logical rules and goals to exploit insights to raise early alerts and alarms in alarm control dashboards.
